(19) United States
(12) Patent Application Publication
(10) Pub. No.: US 2015/0149827 A1
(43) Pub. Date: May 28, 2015

(54) IDENTIFYING A CHANGE TO INDICATE A DEGRADATION WITHIN A COMPUTING DEVICE

(71) Applicants: John Landry, Spring, TX (US); Cesar Augusto Rosa, Cypress, TX (US); Stephen M. DeRoos, Vancouver, WA (US); Eric Gagneraud, Houston, TX (US)

(72) Inventors: John Landry, Spring, TX (US); Cesar Augusto Rosa, Cypress, TX (US); Stephen M. DeRoos, Vancouver, WA (US); Eric Gagneraud, Houston, TX (US)

(21) Appl. No.: 14/397,216

(22) PCT Filed: Apr. 30, 2012
(86) PCT No.: PCT/US2012/035888

§ 371 Date: Oct. 27, 2014

(51) Int. Cl. G06F 11/34

(52) U.S. Cl. CPC G06F 11/3409; G06F 11/3495
USPC 714/37

(57) ABSTRACT

Examples disclose a method to collect a first property and a second property of a computing device. The first property and the second property monitor a functionality of the computing device and are collected as a function of time. Further, the examples provide comparing the first property and the second property to identify a change indicating a degradation within the computing device.

### BACKGROUND

Diagnostics may be performed on computing devices to identify the cause of various degradations and/or failures. Once identifying the causes, the degradation and/or failure may be remedied to restore the computing device to its working state.

### BRIEF DESCRIPTION OF THE DRAWINGS

In the accompanying drawings, like numerals refer to like components or blocks. The following detailed description references the drawings, wherein:

FIG. 1 is a block diagram of an example computing system including a computing device with a profiler module to obtain a first profile with a first property and a second profile with a second property and a diagnostic module to analyze the profiles to identify a change between the properties;

FIG. 2 is a block diagram of an example computing system including a computing device with a profiler module and a diagnostic module to obtain and analyze a first and a second profile to identify a change, a memory to store the change, and a pattern recognition module to receive the change to identify a pattern and based the identification, transmit at least one of a rule and a solution to the computing device;

FIG. 3 is a block diagram of an example memory to store a first profile including a first property and a second profile including a second property representing a type of property information collected from the computing device;

FIG. 4 is a flowchart of an example method performed on a computing device to collect a first property and a second property to compare and identify a change indicating a degradation within the computing device;

FIG. 5 is a flowchart of an example method performed on a computing device to collect a first profile including a first property and second profile including a second property, compare the profiles to identify a change between the first and the second properties, and transmit the identified change to identify a pattern; and

FIG. 6 is a block diagram of a computing device to obtain a first and a second profile with a first and a second property, respectively, compare the profiles to identify a change, store the change, transmit the change to identify a pattern, and receive at least one of a rule and a solution.

### DETAILED DESCRIPTION

By diagnosing a cause of a degradation and/or failure of a computing device, the device may be serviced or remedied. One solution is to diagnose the computing device once a failure has occurred. In this solution, the diagnostics focus on functional validation of the hardware and/or platform of the computing device. However, this solution diagnoses the device in its current state once the failure has occurred. This solution is not able to gain insight into the time and the source of the failure rather, it is more of a reactive approach of diagnostics. Additionally, this solution is performed on a case by case basis for each computing device taking much time from an agent as it ignores the common degradation/failure experienced by multiple computing devices.

In another solution, diagnostics is performed through the process of elimination. In this solution, the potential causes of the degradation and/or failure and testing the computing device. For example, in this solution the platform of the computing device may be reimaged back to the initial state (i.e., manufacturing state) to determine if the failure is resolved. If the problem persists, it is assumed the problem is a hardware issue. This is not an accurate solution as the problem may be a combination of the platform and/or hardware. Further, the source of problem will not be diagnosed until much probing and evaluation, taking additional time from service agents.

To address these issues, example embodiments disclosed herein provide a computing system including a computing device with a profiler module to obtain a first and a second profile. The first and the second profile include a first and a second property of the computing device, respectively, and are obtained as a function of time. Obtaining the properties as a function of time provides snapshots of the computing device at different times to monitor the operation of the computing device. This provides valuable insight into the operational behavior of the computing device. Additionally, by collecting properties provided over time, the source of the problem may be determined.

Further, the computing system includes a diagnostic module to analyze the profiles to identify a change which indicates a degradation (i.e., problem) within the computing device. In this regard, the change indicates the health of the computing device. Identifying the change, reduces the amount of time to diagnose the problem with the computing device. The change provides data of which may be used to diagnose and repair common problems, thereby reducing the amount of time for diagnostics of the computing device. Further, by identifying the change, the computing device may be remedied to prevent a complete failure and/or breakdown.

In another embodiment, the computing system includes a pattern recognition module to receive the change to identify a pattern indicating a related degradation among the computing device and another computing device. Further, once identifying the pattern, the pattern recognition module may transmit at least one of a rule and solution to remedy the degradation within the computing device. Identifying the pattern, common problems may be discovered to help improve hardware and/or platform systems on the computing devices. Additionally, identifying the pattern, computing devices experiencing related degradations may be identified for further diagnostics and improvements. Yet further still, by transmitting at least the rule and solution, the improvement to the source of the degradation may be remedied by improving the diagnostic experience to the user. Further still, by identifying the pattern, the pattern recognition may use structured and unstructured data to determine a common problem occurring within a related hardware and/or platform among multiple computing devices. For example, the structured may collect property data of the computing device which are directly relational to one another, while the unstructured data may include data from service calls, notes, supply chain data, etc. that is not directly relational to one another. Using structured and unstructured data, patterns may be identified leading to the discovery of common problems among the computing devices and thus improving the computing devices to remedy the common problems.

In a further embodiment, a memory module is used to store the change for retrieval. This further helps an agent diagnosing the computing device to quickly analyze the changes to determine the root of cause of the degradation and/or failure.

Yet, in a further embodiment, the first and the second profile are obtained and stored without personal identifying information. Additionally, in this embodiment, the profiles are stored according to a type of property information collected from the computing device. This enables the user anonymity which provides privacy to the user of the computing device. Additionally, it also enables the profiles to be stored in the memory so the service agent may be able to review the data quickly by locating the type of property information in the memory and reviewing the profiles thereby providing further insight into the computing device.

In summary, example embodiments provide a better diagnostic experience to users of computing devices through enabling a proactive approach to handling degradations within the computing device. Additionally, the approach provides valuable insight into the operational behavior of the computing device over time, thereby enabling improvements.

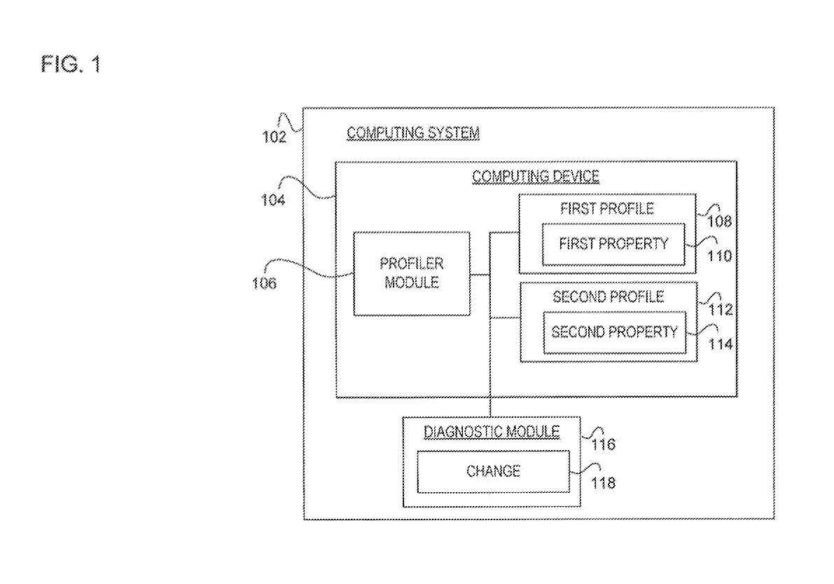

Referring now to the drawings, FIG. 1 is a block diagram of an example computing system 102 including a computing device 104 with a profiler module 106 to obtain a first profile 108 with a first property 110 and a second profile 112 with a second property 114. The computing system 102 also includes a diagnostic module 116 to analyze the first and the second profiles 108 and 112 to identify a change between the first and the second properties 110 and 112. Embodiments of the computing system 102 include a server, a network computing system, or other computing system including the computing device 104 and the diagnostic module 116.

The computing device 104 includes the profiler module 106 to obtain the first profile 108 with the first property 110 and the second profile 112 with the second property 114. Embodiments of the computing device 104 include a client device, personal computer, desktop computer, laptop, a mobile device, a tablet, or other computing device suitable to include the profiler module 106 to analyze the first profile 108 and the second profile 112. In another embodiment, the computing device 104 may include the diagnostic module 116 and/or a memory.

The profiler module 106 obtains the first profile 108 and the second profile 112 to analyze at the diagnostic module 116 to identify the change 118. The profiler module 106 obtains or collects the profiles 108 and 110 periodically or during an event. The profiles 108 and 110 provide the properties 110 and 114 as measurements of the computing device 104. For example, the profiles 108 and 110 may provide properties of each hardware component within the computing device 104, while properties 110 and 114 may include the operating voltage of a specific hardware component. In another embodiment, the profiler module 106 may obtain and/or collect the properties 110 and 114 without collecting the profiles 108 and 112. This embodiment is described in detail in later figures. Embodiments of the profiler module 106 include a set of instructions executable by a processor within the computing device 104 to obtain the first profile 108 and the second profile 112, while other embodiments of the profiler module include a processor, controller, microchip, chipset, electronic circuit, microprocessor, semiconductor, microcontroller, central processing unit (CPU), graphics processing unit (GPU), visual processing unit (VPU), or other programmable device capable of obtaining the profiles 108 and 112.

The first profile 108 provides a collection of properties of the computing device 104 periodically or during an event. The first profile 108 provides a type of snapshot of the operation of the computing device 104 periodically or during an event. For example, the first profile 108 may include a snapshot of the computing device 104 once every few hours, day, or week. The first profile 108 may be obtained according to time intervals or triggered by the computing device 104 event, such as powering on or off the computing device 104. Embodiments of the first profile 108 include providing configuration or functionality properties of the hardware, platform, operating system configuration, applications, processes, installed drivers, and/or hardware diagnostics during the event or time interval. In another embodiment, the first profile 108 may include the initial state of the computing device 104 prior to the life of the computing device.

The first property 110 is included as part of the first profile 108 and includes a specific property of the computing device 104. In this regard, the first property 110 is a smaller subset of the first profile 108, as the first property 110 may include specific property information. In this embodiment, the first property 110 is a type of functional monitoring of the computing device 104. For example, the first profile 108 may include a snapshot of the functionality of the hardware components in the computing device 104, thus the first property 110 includes a smaller subset, such as the functionality of a specific hardware component. In keeping with the example, the first property 110 may be an operating voltage of the processor within the computing device 104.

The second profile 112 provides the collection of properties as obtained at the first profile 108 as later in time or later event. In this embodiment, the second profile 112 provides another snapshot of the operation of the computing device 104 obtained later in time from the first profile 110 or during the similar event as the first profile 108. In one embodiment, the profiles 108 and 112 are obtained without personal identifying information of a user of the computing device 104. Embodiments of the second profile 112 include providing configuration or functionality properties of the hardware, platform, operating system configuration, applications, processes, installed drivers, and/or hardware diagnostics during the event or time interval.

The second property 114 is included as part of the second profile 112 and includes a specific property of the computing device 104. In this regard, the second property 114 is a smaller subset of the second profile 112, as the second property 114 may include a particular subset of property information. The first property 110 and the second property 114 are obtained as a function of time. In one embodiment, this includes time-stamping the first property 108 and the second property 114. In this embodiment, the functionality of the computing device 104 may be monitored over time providing a time-based diagnostics. In another embodiment, the first property 110 and the second property 114 include structured data collecting a particular functionality of the computing device 104. For example, the first property 110 may include a thermal temperature of a processor within the computing device 104, thus the second property 114 would include the thermal temperature of the processor within computing device 104. This direct relation enables the diagnostic module 116 to identify the change 118 indicating the degradation within the computing device 104. In a further embodiment, the first property 110 and the second property 114 monitor a related functionality. In this embodiment, the properties 110 and 114 monitor a common functionality, which allows a direct relation between the properties 110 and 114 to identify the change 118 (i.e., difference). Further in this embodiment, the change 118 may be stored according to the related functionality. For example, the related functionality may include monitoring the thermal temperature of the processor, thus the change 118 may be stored to the thermal temperature of the processor. This enables changes to be retrieved quickly to determine the root cause of a problem within the computing device 104.

The diagnostic module 116 analyzes the first profile 108 and the second profile to identify the change 118 between the first property 110 and the second property 114. Embodiments of the diagnostic module 116 include a set of instructions executable by a processor to analyze the first profile 108 and the second profile 112 to identify the change 118. In another embodiment, the diagnostic module 116 includes a processor on a server to receive the first profile 108 and the second profile 112 to identify the change 118 between the first property 110 and the second property 114. In a further embodiment, the diagnostic module 116 may receive the profiles 110 and 112 from the profiler module 106 to identify the change 118.

The change 118 is a difference between the first property 110 and the second property 114 to indicate the degradation within the computing device 104. This change 118 includes representations signifying the difference between the first property 110 and the second property 114. As such, embodiments of the change 118 include a symbol indicating a functional representation of the computing device 104. For example, the first and second profiles 108 and 112 may include thermal profiles of the computing device 104 obtained at different times. The first property 110 and the second property 114 may include the specific thermal properties of a processor within the computing device. Comparing the first property 110 processor thermal data to the second property 114 processor thermal data, the change may indicate the processor is overheating indicating the degradation of the computing device 104. Recognizing the change 118 indicates the degradation within the computing device 104 prior to failure of the computing device 104. In this embodiment, diagnostics may determine quickly the cause of problem within the computing device 104. Additionally, this enables a proactive approach to handle a problem within the computing device 104 by determining the degradation prior to failure. In another embodiment, the change 118 may be transmitted to a pattern recognition module to identify a pattern indicating a common degradation among multiple computing devices. This embodiment is discussed in detail in later figures. In a further embodiment, the change 118 may be stored in a memory to allow further access and/or retrieval by a service agent to determine the cause of the degradation. This embodiment is discussed in detail in later figures.

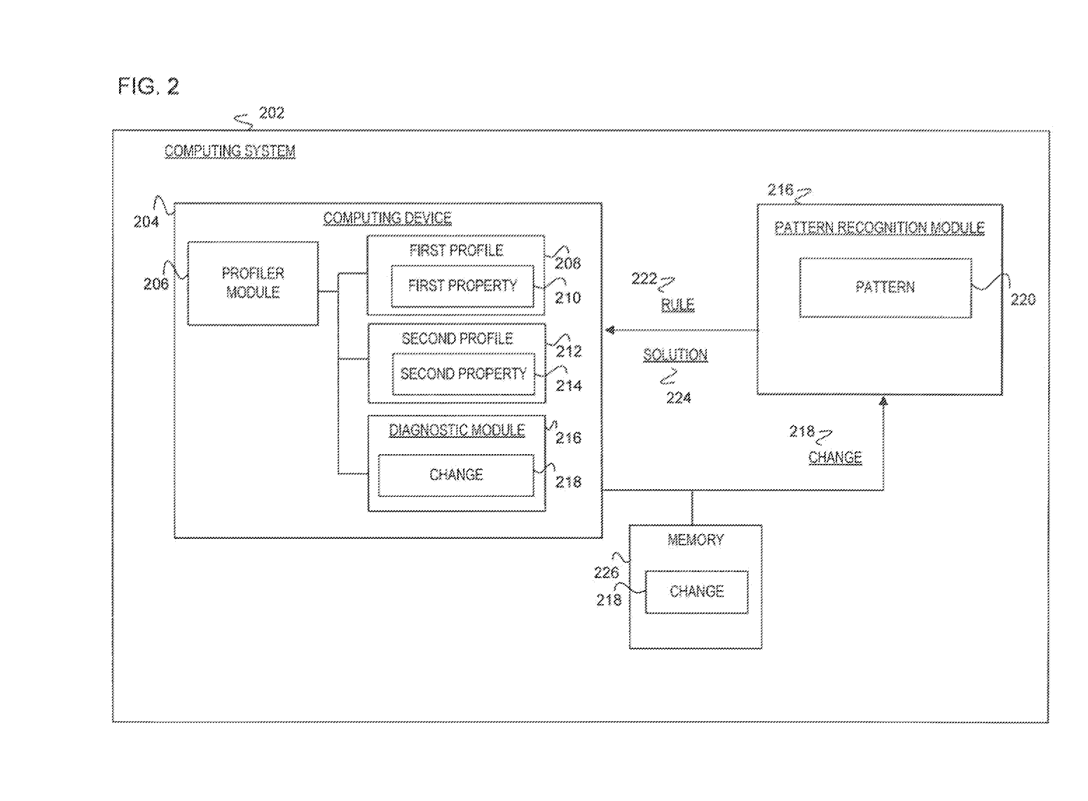

FIG. 2 is a block diagram of an example computing system 202 including a computing device 204 with a profiler module 206 and diagnostic module 216. The profiler module 206 collects a first profile 208 and a second profile 212 and the diagnostic module 216 analyzes the profiles 208 and 212 to determine a change 218 between a first property 210 and a second property 214. Additionally, the computing system 202 includes a memory 224 to store a change 218 as identified by the diagnostic module 216 and a pattern recognition module 216 to receive the change 218, identify a pattern 220, and transmit at least one of a rule 222 and a solution 224. The computing system 202 and the computing device 204 may be similar in structure and functionality of the computing system 102 and the computing device 104 as in FIG. 1.

The profiler module 206 obtains and/or collects the first profile 208 and the second profile 212 including the first property 210 and the second property 214, respectively. The profiler module 206, the first profile 208, the first property 210, the second profile 212, and the second property 214 may be similar in structure and functionality to the profiler module 106, the first profile 108, the first property 110, the second profile 112, and the second property 114 as in FIG. 1.

The diagnostic module 216 analyzes the profiles 208 and 212 to determine the change 218 between the first property 210 and the second property 214. The change 218 is transmitted from the computing device to the memory 226 for storage. In this embodiment, the change 218 may be synched to storage on a network that allows diagnostics if the computing device 204 fails. In another embodiment the change 218 is transmitted to the pattern recognition module 216. In a further embodiment, the profiles 208 and 212 are also transmitted to the pattern recognition module 216 to further track the operation of the computing device 204. The diagnostic module 216 and the change 218 may be similar in structure and functionality to the diagnostic module 116 and the change 118 as in FIG. 1.

The memory 226 stores the change 218 as identified by the diagnostic module 216. Storing the change 218 in the memory 226 provides insight to the operation of the computing device 204. In another embodiment, the change 218 may be retrieved from the memory 226 for further analysis. Embodiments of the memory 226 include a storage, memory buffer, cache, non-volatile memory, volatile memory, random access memory (RAM), an Electrically Erasable Programmable Read-Only memory (EEPROM), storage drive, a Compact Disc Read-Only Memory (CDROM), or other physical storage device capable of storing the change 218.

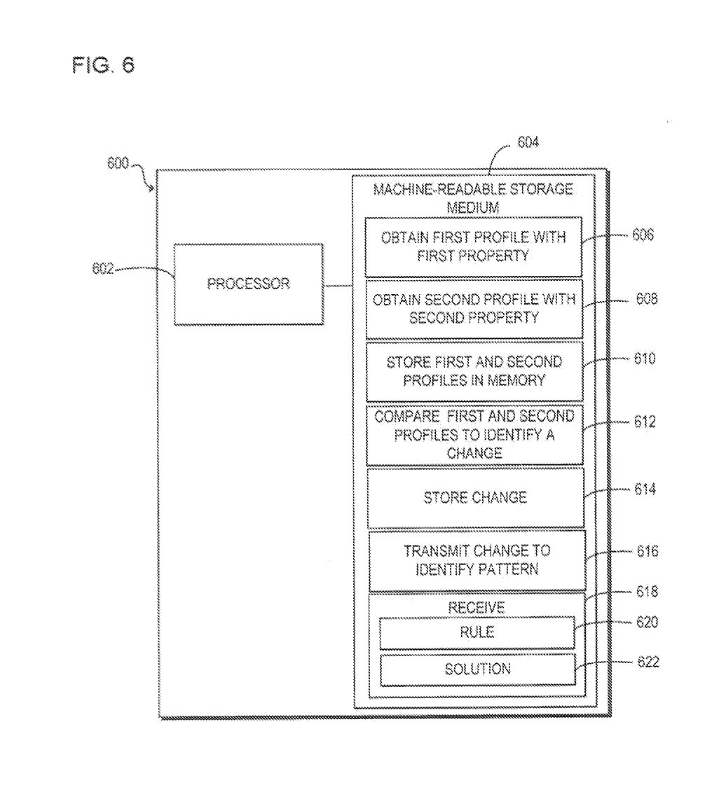

The pattern recognition module 216 receives the change 218 to identify the pattern 220 among multiple computing devices. The pattern 220 indicates a related degradation among the multiple computing devices. In one embodiment, the pattern recognition module 216 receives unstructured data (i.e., no direct relation among the data) and the change 218 to identify the pattern 220. The unstructured data may include service calls, supply chain data, notes, and/or other data to collect and process. In this embodiment, the pattern recognition module 216 processes the change 218 with the unstructured data to identify the pattern among multiple computing devices. In a further embodiment, the pattern recognition module 216 receives the change 218 as from the computing device 204 to identify the pattern 220 among the computing device 204 and another computing device. In this regard, the pattern recognition module 216 identifies the pattern 220 among multiple computing devices to indicate a common degradation of the multiple computing devices. Identifying the pattern 220, the service agent may use to diagnose other degradations and/or failures thereby reducing the amount of time to diagnose and/or repair. Yet in a further embodiment, the properties 210 and 214 are transmitted to the pattern recognition module 216, which indicates the cause of the change, enabling a better diagnosis to determine which hardware and/or software component that is experiencing the degradation. Once identifying the pattern 220, the pattern recognition module 216 may transmit at least one of a rule 222 and a solution 224 to the computing device 204. Embodiments of the pattern recognition module 216 may be implemented in the form of executable instructions stored on a machine-readable storage medium, such as machine-readable storage medium 604 as in FIG. 6, while another embodiment of the pattern recognition module 216 includes or a set of instructions executable by a processor to identify the pattern 220. In a further embodiment, the pattern recognition module may be in the form electronic circuitry capable of identifying the pattern 220.

The pattern 220 is identified by the pattern recognition module 216 and indicates the related degradation in the computing device 204 and other computing devices. In this embodiment, the pattern 220 provides a data representation indicating which hardware and/or software component may be degrading, thus the computing device 204 may readily be identified that may have the potential degradation. Using the pattern 220 to identify which components may be degrading on the computing device 204, reduces the time to diagnose and repair the common degradations. Further, the pattern 220 may also be utilized to improve the components with the degradations.

The rule 222 is transmitted to the computing device 204 as a further way to identify other potential degradations with the computing device 204. In one embodiment, the rule 222 may include a Boolean rule created based on the pattern 220 and transmitted to the computing device 204. In another embodiment, the rule 222 may include a policy to notify the service agent when the change 218 is identified.

The solution 224 may be transmitted to the computing device 204 to remedy the degradation within the computing device 204. The solution 224 may also be identified that may include a link to an upgrade to remedy the problem within the computing device 204 or a remedy for the computing device 204 to execute without further input from a user of the computing device 204.

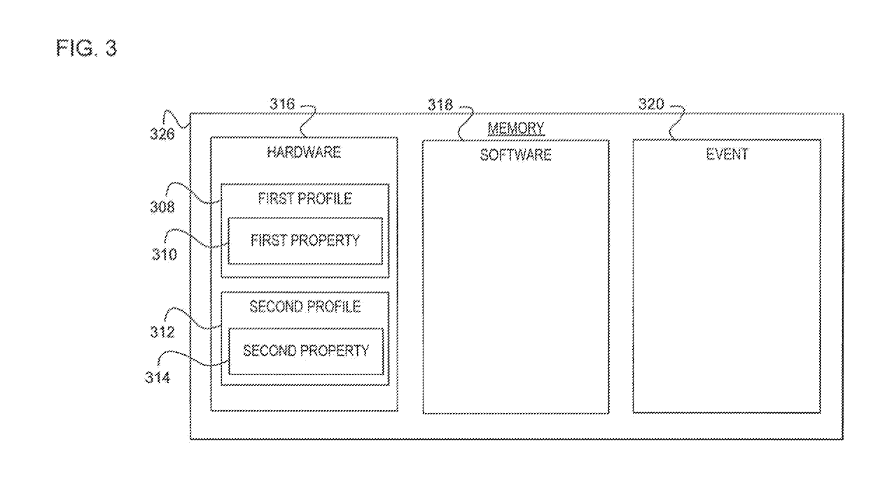

FIG. 3 is a block diagram of an example memory 326 to store a first profile 308 with a first property 310 and a second profile 312 with a second property 314, the profiles 308 and 312 are stored representing property information collected from a computing device. The memory 326, first profile 308, first property 310, second profile 312, and second property 314 may be similar in structure and functionality to the memory 226, first profile 108 and 208, first property 110 and 210, second profile 112 and 212, second property 114 and 214 as in FIG. 1 and FIG. 2, respectively.

The hardware 316, the software 318, and the event 320 represent types of property information collected from the computing device. Storing the profiles 308 and 312 according to the type of property information from the computing device enables a quick and efficient diagnostic as it provides insight into the operation of the computing device. In other embodiments, the profiles 308 and 312 may be stored according to specific functionality obtained including hardware, software, and/or event property data collected. For example, the type of hardware may include processor property data and/or memory property data. Thus, the profiles 308 and 312 may be stored according to the processor property data and/or memory property data. In another example, the profiles 308 and 312 may include property data of applications on the computing device. The properties 210 and 314 may include specific property data about an individual application, thus the profiles 208 and 312 may be stored with the properties 310 and 314 according to the applications. In a further example, the profiles 308 and 312 may include event property data, thus the first property 310 and the second property 314 may include specific event properties. In this example, the profiles 308 and 312 may stored according to the event type, such as powering on the computing device. In these embodiments, the service agent may view the profiles 308 and 312 with the properties 310 and 314 to accurately diagnose a degradation and/or failure within the computing device.

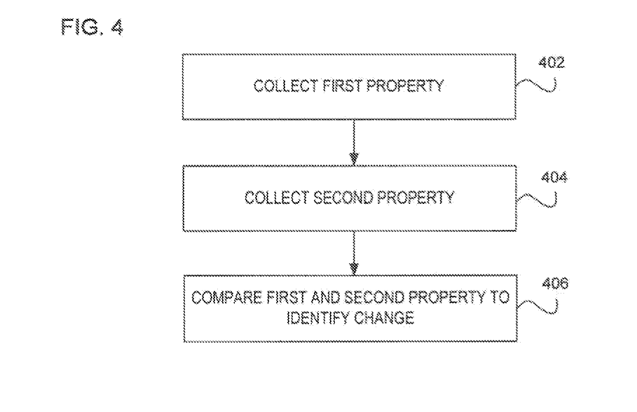

FIG. 4 is a flowchart of an example method performed on a computing device to collect a first and second property to compare and identify a change. Although FIG. 4 is described as being performed on computing device 104 and 204 as in FIG. 1 and FIG. 2, it may also be executed on other suitable components as will be apparent to those skilled in the art. For example, FIG. 4 may be implemented in the form of executable instructions stored on a machine-readable storage medium, such as machine-readable storage medium 604 as in FIG. 6 or in the form of electronic circuitry.

At operation 402, the computing device collects the first property. In one embodiment, the computing device 402 obtains the first property through using sensors located within the computing device to measure the property data of the computing device. In another embodiment of operation 402, the computing device collects a first profile including the first property. Embodiments of operation 402 include time-stamping the first property.

At operation 404, the computing device collects the second property. The first and second properties collected at operation 402 and operation 404 monitor a functionality of the computing device and are obtained as a function of time. For example, the first property and the second property may monitor the operating voltage of the processor or the time an application processes an instruction. In this embodiment, the first and second property are structured (i.e., directly relational) to allow an identification of any difference between these properties. In another embodiment of operation 404, the second property is time-stamped to provide insight into the operation of the computing device over time.

At operation 406, the first property and the second property as collected at operations 402 and 404 are compared to identify a change indicating a degradation within the computing device. This enables a time-based diagnostics to determine a cause of the degradation. In another embodiment of operation 406, the change is transmitted to identify a pattern indicating a related degradation among multiple computing devices. In a further embodiment of operation 406, the change is stored in a memory.

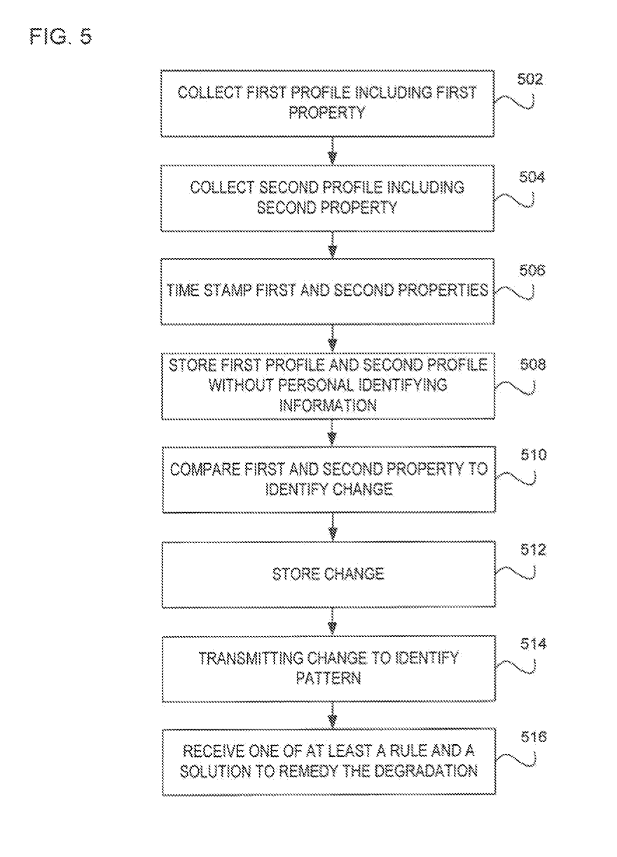

FIG. 5 is a flowchart of an example method performed on a computing device to collect a first profile including a first property and a second profile include a second property. Further, the method compares the profiles to identify a change between the properties and transmits the change to identify a pattern. Although FIG. 5 is described as being performed on computing device 104 and 204 as in FIG. 1 and FIG. 2, it may also be executed on other suitable components as will be apparent to those skilled in the art. For example, FIG. 5 may be implemented in the form of executable instructions stored on a machine-readable storage medium, such as machine-readable storage medium 604 as in FIG. 6 or in the form of electronic circuitry.

Operation 502 collects a first profile including the first property. In an embodiment, operation 502 may time stamp the first profile and/or the first property. In another embodiment, operation 502, collects the first profile from a manufacturer of the computing device. In this embodiment, the manufacturer provides the initial profile as a baseline to measure additional profiles from. Operation 502 may be similar in functionality to operation 402 as in FIG. 4.

Operation 504 collects a second profile including a second property. In an embodiment, operation 504 may time stamp the second profile and/or the second property. Time-stamping the profiles and/or properties enables insight into the operation of the computing device over time. In a further embodiment, operation 504, stores the first and the second profiles according to the type of property information collected. Operation 504 may be similar in functionality to operation 404 as in FIG. 4.

Operation 506 time stamps the first and second properties as collected at operations 502 and 504. In one embodiment, the first and second properties are time stamped at operations 502 and 504, respectively. In this embodiment, the second property is time stamped later in time than the first property.

Operation 508 stores the first profile and the second profile collected at operations 502 and 504 without personal identifying information. In one embodiment, operation 508 occurs after operations 502 and 504. In another embodiment, operation 508 occurs after identifying the change at operation 510. In a further embodiment, operation 508 stores the profiles according to the type of property information collected. For example, the profiles may be stored according to whether the profiles provide property data regarding the hardware components within the computing device, software configurations, and/or events.

Operation 510 compares the first and second property collected at operations 502 and 504 to identify a change indicating a degradation within the computing device. Operation 510 may be similar in functionality to operation 406 as in FIG. 4.

Operation 512 stores the change to a memory as identified at operation 510. In this embodiment, the change provides a data logger for a service agent to review to determine the cause and/or the time of a failure. This allows a comprehensive data log of the operation of the computing device.

Operation 514 transmits the change as identified at operation 510 to identify a pattern among the computing device and another computing device (i.e., multiple computing devices). The identified pattern indicates a related or common degradation detected among the multiple computing devices. In another embodiment operation 514 receives the change and unstructured data to identify the pattern which indicates the common or related degradation among the multiple computing devices. In another embodiment, operation 514, transmits the properties collected at operations 502-504 to detect the cause of the change to diagnose the hardware and/or platform component experiencing the degradation within the computing device. Once identifying the pattern at operation 514, the computing device may receive at least one of a rule and/or a solution as at operation 516.

Operation 516 receives at least one of a rule and a solution to remedy the degradation of the computing device.

Referring now to FIG. 6, a block diagram of an example computing device 600 for obtaining a first and a second profile with a first and a second property, respectively, and to compare the profiles to identify a change between the properties. Additionally, the computing device 600 stores the change, transmits the change to identify a pattern and based on the pattern identification, receives at least one of a rule and a solution. Although the computing device 600 includes processor 602 and machine-readable storage medium 604, it may also include other components that would be suitable to one skilled in the art. For example, the computing device 602 may include a memory 224 as in FIG. 2. Additionally, the computing device 600 includes the functionality of the computing devices 104 and 204 as set forth above in FIG. 1 and FIG. 2.

The processor 604 may fetch, decode, and execute instructions 606, 608, 610, 612, 614, 616, 618, 620, and 622. Embodiments of the processor 602 include a microchip, chipset, electronic circuit, microprocessor, semiconductor, controller, microcontroller, central processing unit (CPU), graphics processing unit (GPU), visual processing unit (VPU), or other programmable device capable of executing instructions 606-622. The processor 602 executes instructions to: obtain a first profile with first property instructions 606; obtain a second profile with second property instructions 608; store the first and second profiles in a memory instructions 610; compare the first and second profiles to identify a change instructions 612; store the change instructions 614; transmit the change to identify a pattern instructions 616; based on the identification of the pattern, receive instructions 618; and at least one of a rule instructions 620 and a solution instructions 622.

The machine-readable storage medium 604 may include instructions 606-622 for the processor 602 to fetch, decode, and execute. The machine-readable storage medium 604 may be an electronic, magnetic, optical, memory, flash-drive, or other physical device that contains or stores executable instructions. Thus, the machine-readable storage medium 604 may include for example, Random Access Memory (RAM), an Electrically Erasable Programmable Read-Only memory (EEPROM), a storage drive, a memory cache, network storage, a Compact Disc Read Only Memory (CD-ROM) and the like. As such, the machine-readable storage medium 604 can include an application and/or firmware which can be utilized independently and/or in conjunction with the processor 602 to fetch, decode, and/or execute instructions on the machine-readable storage medium 604. The application and/or firmware can be stored on the machine-readable storage medium 604 and/or stored on another location of the computing device 600.

The embodiments described in detail herein provide a better diagnostic experience to users of computing devices through enabling a proactive approach to handling degradations within the computing device. Additionally, the approach provides valuable insight into the operational behavior of the computing device over time, thereby enabling improvements.

I claim:

1. A computing system comprising:
a computing device comprising a profiler module to:
obtain a first profile including a first property of the computing device;
obtain a second profile including a second property of the computing device, the first and the second profiles are obtained as a function of time; and
a diagnostic module to:
analyze the first and the second profiles to identify a change between the first and the second properties, the change indicating a degradation within the computing device.

2. The computing system of claim 1 further comprising:
a pattern recognition module to
receive the change to identify a pattern among the computing device and a other computing device, the pattern indicates a related degradation detected among the computing devices; and
based on the identification of the pattern, transmit at least one of a rule and a solution to remedy the degradation within the computing device.

3. The computing system of claim 2 wherein the pattern recognition module is further to:
receive unstructured data to identify the pattern among the computing devices.

4. The computing system of claim 1, wherein the first and the second properties monitor a functionality of the computing device and further comprising:
a memory module to store the change as identified by the diagnostic module, the change stored according the functionality.

5. The computing system of claim 1 wherein the first profile and the second profile are obtained without personal identifying information.

6. The computing system of claim 1 wherein the diagnostic module is within the computing device and is further to receive the first profile and the second profile from the profiler module.

7. A method comprising:
collecting a first property of a computing device;
collecting a second property of the computing device, the first property and the second property monitor a functionality of the computing device and are collected as a function of time; and
comparing the first property and the second property to identify a change, the change indicating a degradation within the computing device.

8. The method of claim 7, wherein the first and the second properties are included in a first and a second profile, respectively, further comprising
storing the first and the second profiles in a memory, the first and the second profiles are stored without personal identifying information and are stored as part of a group representing a type of property information collected from the computing device.

9. The method of claim 7 further comprising:
transmitting the change to identify a pattern among the computing device and another computing device, the pattern indicating a related degradation detected among the computing devices; and
based on the identification of the pattern, receiving at least one of a rule and a solution to remedy the degradation within the computing device.

10. The method of claim 7 further comprising:
storing the change to a memory for retrieval of the change.

11. The method of claim 7 wherein the first and the second properties are collected a function of time is further comprising:
time-stamping the first and second properties.

12. A non-transitory machine-readable storage medium encoded with instructions executable by a processor of a computing device, the storage medium comprising instructions to:
obtain a first profile, the first profile including collect a first property of the computing device;
obtain a second profile, the second profile including a second property of the computing device, the first and the second properties are collected as a function of time and monitor a functionality of the computing device; and
compare the first profile and the second profile to identify a change between the first property and the second property, the change indicating a degradation within the computing device.

13. A non-transitory machine-readable storage medium including the instructions of claim 12, further comprising instructions to:
store the first and the second profiles in a memory, the first and second profiles are stored as part of a group, the group representing a type of property information collected from the computing device.

14. A non-transitory machine-readable storage medium including the instructions of claim 12, further comprising instructions to:
transmit the change to identify a pattern among the computing device and another computing device, the pattern indicates a related degradation detected among the computing devices;
based on the identification of the pattern, receiving at least one of a rule and a solution to remedy the degradation within the computing device.

15. A non-transitory machine-readable storage medium including the instructions of claim 12, further comprising instructions to:
store the change to a memory for retrieval of the change.
